(19) United States
(12) Patent Application Publication
(10) Pub. No.: US 2005/0022414 A1
(43) Pub. Date: Feb. 3, 2005

(54) Method and apparatus for removing vapor within heat pipe

(76) Inventor: Hul-Chun Hsu, Taichung (TW)

Correspondence Address: Yi-Wen Tseng, 4331 Stevens Battle Lane, Fairfax, VA, 22033, US

(21) Appl. No.: 10/843,624

(22) Filed: May 12, 2004

(30) Foreign Application Priority Data
Jul. 18, 2003 (TW) 092119623

(51) Int. Cl. F26B 13/30

(52) U.S. Cl. 34/92

(57) ABSTRACT

A method and an apparatus for removing vapor within a heat pipe. A predetermined amount of working fluid is injected into the heat pipe. The opening of the heat pipe is communicated with a vacuum environment. By controlling the working fluid to be evaporating instead of being boiling, the vapor is exhausted. The apparatus includes a valve, a vacuum apparatus and a vacuum conduit serially connected between the vacuum apparatus and the valve. The valve has one end distal to the vacuum apparatus connected to the heat pipe. The valve is normally off and intermittently switched on and off.

### BACKGROUND OF THE INVENTION

The present invention relates generally to a method and an apparatus for removing vapor within a heat pipe and, more particularly, to a method and an apparatus that can remove vapor within a thermal tube while precisely controlling the amount of the working fluid to be sealed in the heat pipe.

Heat pipes, by having the features of quick thermal response, high thermal conductivity, no moving parts, simple structure and multi-functions, can transfer huge amount of heat without consuming significant amount of electricity. Therefore, heat pipes are suitable for heat dissipation of electronic products. In addition, the interior wall of the conventional heat pipe includes wick structure. The wick structure includes web for capillary effect, which is advantageous for transmission of working fluid in the heat pipe.

However, while fabricating the heat pipes, the vapor within the heat pipe is typically exhausted together with the liquid working fluid, such that the remaining amount of the working fluid within the heat pipe cannot be precisely controlled. The control quality of the heat pipes is thus very poor. Further, the incompleteness of vapor within the heat pipes results in poor heat flow effect.

Therefore, there exist inconvenience and drawbacks for practically application of the above conventional heat pipes. There is thus a substantial need to provide a method and an apparatus for removing vapor within a heat pipe that resolves the above drawbacks and can be used more conveniently and practically.

### BRIEF SUMMARY OF THE INVENTION

The present invention provides a method and an apparatus for removing vapor within a heat pipe. During the process of exhausting vapor within the heat pipe, the amount of working fluid within the heat pipe is precisely controlled, and the vapor is more thoroughly removed. Therefore, a stable amount of the working fluid is maintained, heat pipes with improved quality are fabricated, and a better heat flow is obtained.

To achieve the above and other objectives, the present invention provides a method to remove vapor within a heat pipe. The method comprises the following steps. A predetermined amount of working fluid is injected into a heat pipe. An opening is reserved at one end of the heat pipe. The opening is communicated with a vacuum environment. A normally off is maintained between the opening and the vacuum environment to isolate the vacuum environment from the heat pipe, such that at the instant the isolation status is relieved, the vacuum level of the vacuum environment is maintained at a certain range. The isolation status between the opening of the heat pipe and the vacuum environment is relieved for at least once. Within the duration while the isolation status between the opening and the vacuum environment is relieved, the working fluid is evaporated without being boiled and vapor is exhausted from the opening.

The apparatus provided by the present invention includes a valve, a vacuum apparatus and a vacuum conduit serially connecting the valve and the vacuum apparatus. The valve has one end distal to the vacuum apparatus connected to the heat pipe. The valve is normally off and can be intermittently switched on and off. Thereby, an apparatus for removing vapor within the heat pipe is thus assembled. The apparatus is operative to exhaust vapor within the heat pipe while precisely controlling the amount of working fluid in the heat pipe

### BRIEF DESCRIPTION OF THE DRAWINGS

These, as well as other features of the present invention, will become more apparent upon reference to the drawings wherein:

FIG. 1 shows a process of the method for removing vapor within a heat pipe according to the present invention;

FIG. 2 shows the operation of the apparatus provided by the present invention; and

FIG. 3 shows a local enlarged view of FIG. 2.

### DETAILED DESCRIPTION OF THE INVENTION

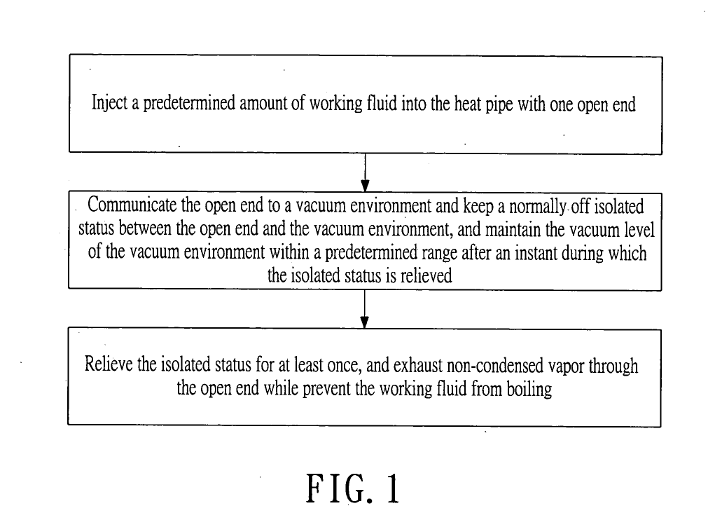

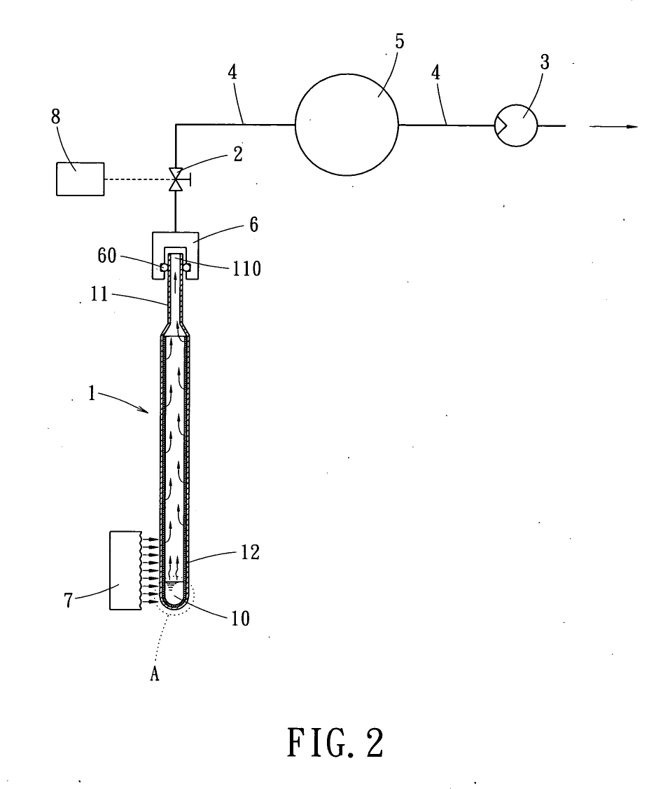

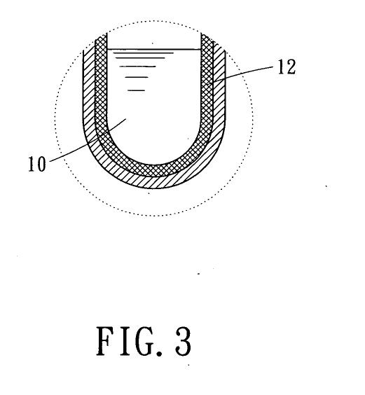

Referring to FIGS. 1 and 2, the process flow of the method and operation of the apparatus for removing vapor within a heat pipe provided by the present invention are illustrated. The method includes injecting a predetermined amount of working fluid 10 into a heat pipe 1 (as shown in FIG. 3). An opening 110 is reserved at one end of the heat pipe 1. Preferably, the predetermined amount is slightly more than the amount of working fluid to be sealed in the heat pipe 1. The interior wall of the heat pipe 1 includes wick structure 12, while the opening is formed at the sealing end 11 of the heat pipe.

The opening 110 is communicated to a vacuum environment. The connection between the opening 110 and the vacuum environment is normally-off and isolated from each other. At the transient the isolation status between the opening 110 and the vacuum environment is relieved, the vacuum level of the vacuum environment is maintained within a certain range. This is achieved by continuously pumping the vacuum environment. The interior capacity of the vacuum environment is preferably far larger than that of the heat pipe. In this embodiment, the vacuum environment includes a pressure buffer 5 and a vacuum circuit 4 as shown in FIG. 2. The isolation between the opening 110 of the heat pipe 1 and the vacuum environment includes a valve 2.

The isolation between the opening 110 of the heat pipe 1 and the environment is relieved for at least once, and the working fluid within the thermal 1 is evaporating and prevented from being boiling while vapor is exhausted. In this step, the working fluid within the heat pipe 1 is prevented from being boiling to spray out of the thermal tube 1 that may lose control of the remaining amount of the working fluid within the heat pipe 1. Therefore, the isolation is relieved under the circumstance that the working fluid 10 is evaporating, but is not boiling. Once the isolation is relieved, a negative pressure is formed near the opening 110 of the heat pipe 1 to instantly vaporize the working fluid 10. Therefore, the isolation has to be retrieved immediately to avoid the working fluid 10 spraying out due to boiling. That is, a small amount of the exhausted vapor is maintained, and the remaining amount of the working fluid 10 within the heat pipe 1 is precisely controlled. The duration for relieving the isolation status depends on the required amount the working fluid to be sealed in the heat pipe 1, the dimension of the heat pipe 1, and the gauge of the opening 110.

If the residual vapor in the heat pipe 1 after one exhaust exceeds a tolerable range, the step of relieving the isolation between the opening 110 and the vacuum environment is repeated until the amount of the residual vapor falls within the tolerable range.

In addition, to accelerate the exhaust of the vapor accumulated near the opening 110 of the heat pipe 1, the bottom end of the heat pipe 1 is heated to cause a temperature gradient from the bottom to the top end (sealing end) of the heat pipe 1. Thereby, the gas and liquid within the heat pipe 1 are circulated, allowing vapor accumulated near the top end of the heat pipe 1. When the opening 110 is conducted with the vacuum environment, the vapor near the opening 110 is first exhausted. Therefore, the remaining amount of the working fluid 10 within the heat pipe 10 can be precisely controlled to enhance the exhaust efficiency.

When the amount of the vapor within the heat pipe 1 is within the tolerable range, the sealing end 11 of the heat pipe 1 is sealed.

By the above processes, a heat pipe 1 within which vapor has been exhausted is obtained.

Referring to FIG. 2, the present invention further provides an apparatus for removing vapor within a heat pipe. The apparatus comprises a valve 2, a vacuum apparatus 3 and a vacuum conduit 4 serially connected between the valve 2 and the vacuum apparatus 3.

The valve 2 includes a solenoid valve or a pneumatic valve, and the vacuum apparatus 4 includes a vacuum pump, for example. When the vacuum conduit 4 is serially connected to the valve 2 and the vacuum apparatus 4, the valve 2 is conducted with the vacuum apparatus 3. Thereby, a vacuum condition is maintained by continuous operation of the vacuum apparatus 4. A pressure buffer 5 may further be installed on the vacuum conduit 4 between the valve 2 and the vacuum apparatus 3. The pressure buffer 5 includes an accumulator, for example, to temporarily store the exceeding pressure within the heat pipe 1, so as to stabilize the vacuum level within the vacuum pipe 4. In the above mentioned method, the vacuum environment includes the vacuum conduit 4, or the assembly of the vacuum conduit 4 and the pressure buffer 5. The vacuum level within the vacuum conduit 4 and the pressure buffer 5 is maintained by continuously operation of the vacuum apparatus 3.

A pipe connector 6 is further installed at one end of the valve 2 distal to the vacuum apparatus 3. The pipe connector 6 is used to connect the opening 110 of the heat pipe. A gas sealing ring 60 is included between the pipe connector 6 and the opening 110 to ensuring a proper sealing effect at the joint of the pipe connector 60 and the heat pipe 1. In addition, to accelerate exhaust of the vapor, a heating apparatus is provided at the bottom end of the heat pipe 1.

The valve 2 is normally off and intermittently switched on and off. A controller 8 is used to control the number of switch operation, the duration for each switch operation, and the time interval between the switch operations. The controller 8 comprises a programmable logic controller (PLC), by which a small amount of vapor is exhausted each time, while the amount of the working fluid 10 within the heat pipe is precisely controlled.

According to the above, an apparatus for removing vapor within a heat pipe is obtained.

By the present invention, a method and an apparatus for removing vapor within a heat pipe are provided. By the method and the apparatus provided by the present invention, the amount of the working fluid to be sealed within the heat pipe can be precisely controlled during the exhaust process of the vapor within the heat pipe. The quality of the heat pipe is thus enhanced, and a better thermal flow can be obtained.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A method of removing vapor within a heat pipe, comprising:
a) injecting a predetermined amount of working fluid into the heat pipe, and forming an opening on a top end of the heat pipe;
b) communicating the opening with a vacuum environment and keeping a normally off isolation status between the opening and the vacuum environment, such that vacuum level of the vacuum environment is maintained within a predetermined range after the isolation status is relieved for an instant; and
c) relieving the isolation status between the opening and the vacuum environment for at least once when the working fluid within the heat pipe is evaporating without being boiling.

2. The method of claim 1, wherein step (b) further comprises continuously vacuuming the vacuum environment to maintain the vacuum level thereof.

3. The method of claim 1, wherein step (b) further comprises communicating the opening with the vacuum environment with an interior capacity larger than that of the heat pipe.

4. The method of claim 1, wherein step (c) further comprises a step of heating a bottom end of the heat pipe to generate a temperature gradient.

5. The method of claim 1, wherein step (c) further comprises retrieving the isolation status between the opening and the vacuum environment before the working fluid within the heat pipe is boiling.

6. The method of claim 5, further comprising repeating step (c) until amount of residual vapor within the heat pipe is within than a tolerable range.

7. The method of claim 1, further comprising a step of sealing the opening when the amount of vapor within the heat pipe is within a tolerable range.

8. An apparatus for removing vapor within a heat pipe, comprising a valve, a vacuum apparatus, and a vacuum conduit serially connected between the valve and the vacuum apparatus, wherein one end of the valve distal to the vacuum apparatus is connected to the heat pipe, and the valve is normally off and switched on and off intermittently.

9. The apparatus of claim 8, wherein the valve includes a solenoid valve.

10. The apparatus of claim 8, wherein the valve includes a pneumatic valve.

11. The apparatus of claim 8, wherein the distal end of the valve includes a pipe connector and a gas sealing ring to be mounted between the heat pipe and the pipe connector.

12. The apparatus of claim 8, further comprising a controller to control frequency of switch operations, duration of each switch operation, and time interval between switch operations of the valve.

13. The apparatus of claim 12, wherein the controller comprises a programmable logic controller.

14. The apparatus of claim 8, wherein the vacuum apparatus comprises a vacuum pump.

15. The apparatus of claim 8, further comprises a pressure buffer installed on the vacuum conduit between the vacuum apparatus and the valve.

16. The apparatus of claim 15, wherein the pressure buffer includes an accumulator.

17. The apparatus of claim 8, further comprising a heating apparatus at a bottom end of the heat pipe.
